(19) United States
(12) Patent Application Publication
(10) Pub. No.: US 2021/0257643 A1
(43) Pub. Date: Aug. 19, 2021

(54) INEXPENSIVE AND EFFICIENT ORGANIC REDOX FLOW BATTERY CONFIGURATIONS FOR LARGE-SCALE ENERGY STORAGE

(71) Applicant: UNIVERSITY OF SOUTHERN CALIFORNIA, Los Angeles, CA (US)

(72) Inventors: Sri R. NARAYAN, Arcadia, CA (US); Bo YANG, Los Angeles, CA (US); Buddhinie Sirmali JAYATHILAKE, Los Angeles, CA (US); Advaith MURALI, Pasadena, CA (US); Archith NIRMALCHANDAR, Los Angeles, CA (US); G.K. Surya PRAKASH, Hacienda Heights, CA (US)

(73) Assignee: UNIVERSITY OF SOUTHERN CALIFORNIA, Los Angeles, CA (US)

(21) Appl. No.: 16/973,922

(22) PCT Filed: May 24, 2019
(86) PCT No.: PCT/US2019/033928

§ 371 Date: Dec. 10, 2020

Related U.S. Application Data
(60) Provisional application No. 62/682,988, filed on Jun. 10, 2018.

(51) Int. Cl. H01M 8/18

(52) U.S. Cl. CPC H01M 8/188

(57) ABSTRACT

A flow battery that includes an iron-based redox couple includes a positive electrode, a positive electrode electrolyte including a soluble iron-based redox couple, a negative electrode, and a negative electrode electrolyte including a cyclic organic-based redox couple. The positive electrode electrolyte flows over and contacting the positive electrode. The iron-based redox couple includes an iron-containing compound which is reduced during discharge. The negative electrode electrolyte flows over and contacting the negative electrode. The cyclic organic-based redox couple includes a cyclic organic compound. The reduction product of the cyclic organic compound being oxidized to the cyclic organic compound during discharge.

### CROSS-REFERENCE TO RELATED APPLICATIONS

This application claims the benefit of U.S. provisional application Ser. No. 62/682,988 filed Jun. 10, 2018, the disclosure of which is hereby incorporated in its entirety by reference herein.

### TECHNICAL FIELD

In at least one aspect, the present invention relates to redox flow batteries

### BACKGROUND

The intermittent nature of renewable energy sources such as solar and wind energy presents challenges to integration with the electrical grid specifically in balancing the energy supply and demand. If rechargeable battery systems can be made inexpensive and long-lasting, they can be deployed at a large-scale to solve this problem of integration of renewable energy into the electric supply. To this end, redox flow batteries are particularly attractive for storing large amounts of electrical energy.

In a redox flow battery, the redox active material is stored as electrolyte solutions in a tank external to the battery stack. During charge and discharge, the redox materials (or electrolytes as they are often termed) are converted reversibly into their chemically oxidized and reduced forms. The electrolyte solutions are pumped through the battery stack during battery operation. Battery stack is a series combination of cells consisting of a positive electrode (cathode), membrane separator and negative electrode (anode). Several battery stacks may either be combined in series or parallel with other stacks to deliver the required output of power at the desired voltage.

Since redox flow batteries are expected to store large amounts of energy (tens of kilowatt-hours to several megawatt hours), their cost per kilowatt-hour of energy stored must be extremely low to be economically viable. For systems to be commercially attractive their capital cost must be in the range of $100/kWh. To achieve this low cost, the redox materials must be durable and inexpensive. The state-of-art redox flow batteries use expensive materials such as vanadium and hence large-scale commercialization has not happened. The subject of this set of inventions is the demonstration of a flow battery that uses particularly low-cost materials such as small organic molecules and iron-based electrolytes that can be rapidly interconverted between their oxidized and reduced forms to achieve high power density and high efficiency of electrical energy storage.

Accordingly, there is a need for improved flow battery components that is inexpensive and efficient.

### SUMMARY

The present invention solves one or more problems of the prior art by providing in at least one aspect, a flow battery that includes an iron-based redox couple. The flow battery includes a positive electrode, a positive electrode electrolyte including a soluble iron-containing compound that is part of an iron-based redox couple, a negative electrode, and a negative electrode electrolyte including a cyclic organic-based redox couple. The positive electrode electrolyte flows over and contacting the positive electrode. The soluble iron-containing compound is reduced during discharge and oxidized during charging. The negative electrode electrolyte flows over and contacting the negative electrode. The cyclic-based redox couple includes a cyclic organic compound. The reduction product of the cyclic organic compound being oxidized to the cyclic organic compound during discharge.

In another aspect, a flow battery that includes an iron-based redox couple is provided. The flow battery includes a positive electrode, a positive electrode electrolyte including a soluble iron-containing compound that is part of an iron-based redox couple, a negative electrode, and a negative electrode electrolyte. The positive electrode electrolyte flows over and contacts the positive electrode with the soluble iron-containing compound being reduced during discharge and oxidized during charging. Characteristically, the iron-containing compound is iron (1) chloride, iron (II) bromide, iron (II) sulfate, iron (II) methanesulfonate, iron (II) sulfamate, iron (II) triflate, or complexes of iron and organic ligands. The negative electrode electrolyte includes a cyclic organic compound that is part of a cyclic organic-based redox couple with the negative electrode electrolyte flowing over and contacting the negative electrode. A reduction product of the cyclic organic compound is oxidized to the cyclic organic compound during discharge and the cyclic organic compound is reduced during charging.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1. Schematic of a Redox Flow Battery.

FIG. 2. Reactions during charge and discharge at the positive and negative electrodes of an iron/anthraquinone battery.

FIG. 3. Linear sweep voltammetry at a rotating disk electrode for iron(II) sulfate and anthraquinone disulfonic acid (AQDS). Scan rate was 50 mV s⁻¹.

FIG. 4. Capacity of iron/AQDS cell during cycling of asymmetric (M FeSO4, 1M AQDS) and symmetric cells (0.67M FeSO4, 0.33M AQDS).

FIG. 5. Circuit voltage for the conditions of FIG. 5.

FIG. 6. Current-Voltage performance of iron/AQDS asymmetric cell at 100% state-of-charge.

FIG. 7. Cyclic voltammetry and linear sweep voltammetry at a rotating disk electrode of sulfonated dihydroxyanthraquinone in 1M sulfuric acid. The potential is with respect to the mercury sulfate reference electrode.

FIG. 8. Cyclic voltammogram of 1 mM AQDSNa₂ (disodium salt) dissolved in 1 M potassium hydroxide.

FIG. 9. Cycling of alkaline cell with potassium hexacyanoferrate (II) in 1 M potassium hydroxide against riboflavin phosphate redox couple. Riboflavin has similar electrode potentials as anthraquinone disulfonate shown in FIG. 10.

FIGS. 10A and 10B. Rotating disk voltammetry on iron(II) chloride. 1 mM FeCl2 in 1M sulfuric acid, scan rate 50 mV/second, Glassy carbon electrode, MSE reference electrode. Rotating disk voltammetry at 1500 rpm

FIGS. 11A and 11B. (A) Cycling of iron (II) chloride/AQDS cell. (B) asymmetrical, 2M FeCl₂, 4M HCl/1M AQDS, HCl, N212, CNT felt, forced flow through, 100 mA/cm².

FIGS. 12A and 12B. (A) Cyclic disk voltammetry on iron(II) methanesulfonate. (B) Rotating disk voltammetry on iron(II) methanesulfonate. CV and RDE of cycled FeCl2 in 1M sulfuric acid, CV scan rate 50 mV/s, RDE at 1500 rpm, glassy carbon electrode, potential vs MSE reference electrode.

FIGS. 13A and 13B. Cycling behavior of iron(II) methanesulfonate. (A) Asymmetrical cell, 1M Femethanesulfonate, 2M methanesulfonic acid/0.5M AQDS, 2M methane sulfonic acid, N117, felt, IDF, 100 mA/cm. (B) Asymmetrical cell, 1M Femethanesulfonate, 2M methanesulfonic acid/0.5M AQDS, 2M methane sulfonic acid, N117, felt, IDF, 100 mA/cm².

FIG. 14. Cyclic voltammetry for iron(II) sulfamate.

FIGS. 15A and 15B. Cycling behavior of iron(II) sulfamate/ADQS cell. (A) Symmetrical cell, 0.42M AQDS, 0.84 H₂NSO₃, N212, CNT felt, IDF, 20 mA/cm². (B) Symmetrical cell, 0.42M AQDS, 0.84 H₂NSO₃, N212, CNT felt, IDF, 20 mA/cm².

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include alkyl, lower alkyl, C₁₋₆ alkyl, C₆₋₁₀ aryl, C₆₋₁₀ heteroaryl, —NO₂, —NH₂, —N(R′R″), —N(R′R″R′″)₃⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH₃, and —CFR′R″ where R′, R″ and R′″ are C₁₋₁₀ alkyl or C₆₋₁₈ aryl groups; single letters (e.g., “n” or “o”) are 1, 2, 3, 4, or 5; in the compounds disclosed herein, Exhibit a CH bond can be substituted with alkyl, lower alkyl, C₁₋₆ alkyl, C₆₋₁₀ aryl, C₆₋₁₀ heteroaryl, —NO₂, —NH₂, —N(R′R″)₂, —N(R′R″R′″)₃⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH₃, and —CFR′R″ where R′, R″ and R′″ are C₁₋₁₀ alkyl or C₆₋₁₈ aryl groups; percent, “parts of” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, that a wavy line crossing a straight solid line indicates the point of attachment for a functional group.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g., pressure) can be practiced with plus or minus 50 percent of the values indicated rounded to three significant figures. In a refinement, concentrations, temperature, and reaction conditions (e.g., pressure) can be practiced with plus or minus 30 percent of the values indicated rounded to three significant figures of the value provided in the examples. In another refinement, concentrations, temperature, and reaction conditions (e.g., pressure) can be practiced with plus or minus 10 percent of the values indicated rounded to three significant figures of the value provided in the examples.

Throughout this application, where publications are referenced, the disclosures of these publications in their entireties are hereby incorporated by reference into this application to more fully describe the state of the art to which this invention pertains.

The term “standard electrode potential” means the electrical potential (i.e., the voltage developed) of a reversible electrode at standard state in which solutes are at an effective concentration of 1 mol/liter, the activity for each pure solid, pure liquid, or for water (solvent) is 1, the pressure of each gaseous reagent is 1 atm., and the temperature is 25° C. Standard electrode potentials are reduction potentials.

The term “cyclic organic compound” refers to compounds having at least one cyclic hydrocarbon group. Such cyclic hydrocarbon groups can be substituted with a hetero atom (e.g., N, O, S). Typically, such cyclic organic compound with have one or more aryl (e.g., C₆ aryl ring such as a benzene ring) or heteroaryl rings (e.g. C₃₋₆ heteroaryl). Variations include 1, 2, 3, or more of such aryl and/or heteroaryl rings.

Abbreviations:

“MSE” is mercury sulfate reference electrode.

“MMO” is mixed mercury-mercuric oxide.

“AQS” is anthraquinone-2-sulfonic acid.

“AQDS” is anthraquinone disulfonic acid.

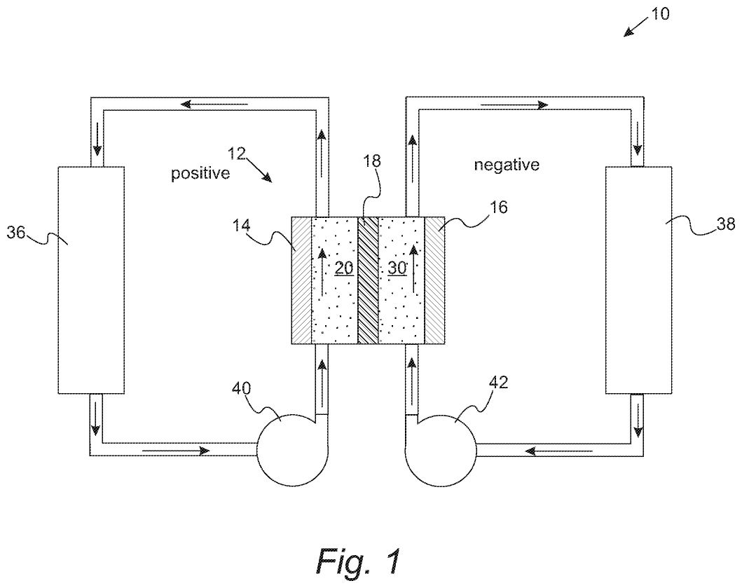

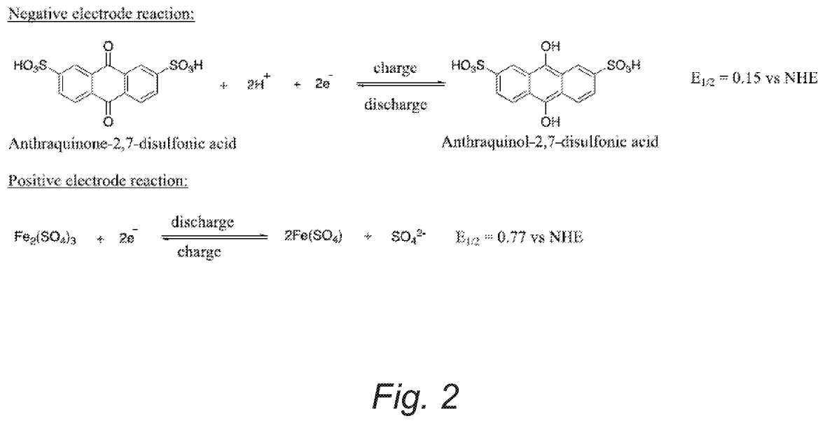

With reference to FIGS. 1 and 2, schematic illustrations of a flow battery that includes a pair of redox couples is provided. Flow battery 10 includes battery cell 12 which includes positive electrode 14, negative electrode 16, and optional membrane 18. In the context of a flow cell, reduction occurs during discharge at the positive electrode and oxidation occurs during discharge at the negative electrode. Conversely, oxidation occurs during charging at the positive electrode and reduction occurs during charging at the negative electrode. Optional membrane 18 is interposed between positive electrode 14 and negative electrode 16. Optional can be a polymer electrolyte membrane or an anion exchange membrane. Positive electrode electrolyte 20 includes water and a soluble iron(II)-containing compound(s) that are part of a first redox couple 22. Positive electrode electrolyte 20 flows over and contacts positive electrode 14. First redox couple 22 includes an iron-containing couple. The iron-containing couple includes an Fe(II)-containing compound (e.g., iron sulfate) and an oxidation product of this compound (i.e., an Fe(III)-containing compound). Examples of the example of the Fe(II)-containing compound include, but are not limited to, iron (II) chloride, iron (II) bromide, iron (II) sulfate, iron (II) methanesulfonate, iron (II) sulfamate, iron (II) triflate, and combinations thereof.

Negative electrode electrolyte 30 flows over and contacts the negative electrode 16. Negative electrode electrolyte 16 includes a solvent (e.g., water) and a second redox couple 32. The second redox couple 32 includes a cyclic organic compound (e.g., anthraquinone disulfonic acid) and a reduction product of the cyclic organic compound. For example, a derivative of anthraquinone as the negative electrolyte and a soluble iron-based redox couple as the positive electrolyte is proposed. An example of the anthraquinone material is anthraquinone-2,7-disulfonic acid. The reactions occurring in the cell during charge and discharge for this example are shown in FIG. 2.

During discharge of the flow battery, the Fe(III)-containing compound is reduced to the Fe(II)-containing compound. During charging of the flow battery, the Fe(II)-containing compound is oxidized to Fe(III)-containing compound. Negative electrode electrolyte 30 includes water and a second redox couple 32. During discharge, the reduction product of the cyclic organic compound is oxidized. During charging of the flow battery, the cyclic organic compound is reduced. For the example depicted in FIG. 2, during charging of the battery, iron(II) sulfate will be converted to iron(III) sulfate, and anthraquinone disulfonic acid (AQDS) will be reduced to the anthraquinol. These reactions are reversed during discharge. While the 2, 7-isomer of AQDS is indicated in the equations, other isomers such as the 2,6-AQDS, 1,8-AQDS, and 2,5-AQDS are also viable. These various isomers will be referred to collectively as AQDS. Anthraquinone monosulfonic acid (AQS) with the sulfonic acid in the 1 or 2 positions is also suitable as a negative material.

In a variation, the concentration of the iron(II)-containing compound is initially from about 0.1 mM to 2M. Similarly, concentration of the cyclic organic compound is initially from about 0.1 mM to 2M. “Initially” in this context means the amount charge to a solvent (e.g., water) when the electrolytes are prepared.

In a refinement, the iron-containing compound has a standard electrode potential that is at least 0.3 volts higher than a standard electrode potential (e.g., MSE) for the cyclic organic compound (e.g., the second quinone). In one refinement, no non-aqueous organic solvents are used in the flow cell. In another refinement, solvents in addition to water are used. Examples of additional solvents include, but are not limited to, dimethylformamide, C₁₋₄ alcohols, acetone nitrile, and combinations thereof. The positive electrode electrolyte and the negative electrode electrolyte can both be independently operated at a pH from 0 to 14. In one refinement, the positive electrode electrolyte and the negative electrode electrolyte can both be independently operated under acidic conditions from 0 to 7 (e.g. pH from 0 to 6.9). In one refinement, the positive electrode electrolyte and the negative electrode electrolyte can both be independently operated under acidic conditions from a pH greater than 7 to 14 (e.g., pH from 7.1 to 14) conditions. In one useful refinement, the positive electrode electrolyte and/or the negative electrode electrolyte each independently have a pH from 9 to 14. Advantageously, no soluble heavy metals are used in this battery system. Moreover, the battery cell can be operated in an acidic or alkaline environment.

Still referring to FIG. 1, flow battery 10 further includes a positive electrode reservoir 36 in fluid communication with the positive electrode 14. The positive electrode electrolyte 20 is stored in the positive electrode reservoir 36 to charge and discharge the flow battery. The positive electrode electrolyte cycles through battery cell 12 from positive electrode reservoir 36 via the pumping action of pump 40. A negative electrode reservoir 38 is in fluid communication with the negative electrode 16. The negative electrode electrolyte 30 is stored in the negative electrode reservoir 36 to charge and discharge the flow battery. The negative electrode electrolyte cycles through battery cell 12 from negative electrode reservoir 38 via the pumping action of pump 42.

As set forth above, the positive electrolyte can include an iron(II)-containing compound such as iron (II) chloride, iron (II) bromide, iron (II) sulfate, iron (II) methanesulfonate, iron (II) sulfamate, iron (II) triflate, and combinations thereof. Iron (II) chloride has the advantage of achieving concentrations as high as 3.25 Molar. In a refinement, solutions (e.g., aqueous solutions) of these compounds can also include an acid such as sulfuric, hydrochloric or hydrobromic acid to ensure that precipitation of iron hydroxides does not occur. In another refinement, double salts such as ferrous ammonium sulfate and ferrous ammonium chloride or bromide are also suitable. In another variation, the iron(II)-containing compound can be complexes of iron (i) and iron (III) formed with organic ligands such as citrate, ascorbate, gluconate, fumarate, EDTA and salicylate. Moreover, the electrochemistry of iron(II) in any of these salts is expected to be similar. Consequently, iron chloride, iron sulfate and iron bromide are expected to yield the same level of performance as a flow battery. However, some differences in the solubility of these materials could result in different values of maximum power density.

In another variation, the flow battery set forth above can be operated in a temperature range of 20 to 90 degrees Celsius. The effects of temperature are to enhance the kinetics of charge transfer, increase the value of the diffusion coefficient and lower the viscosity of the solution. The net effect of increasing the temperature would be an increase in power density and energy efficiency.

While the iron (II) sulfate/AQDS cell has been shown to perform well, other configurations of the battery cell depicted in FIG. 1 can provide improved performance and reduction in cost. In a variation, membrane 18 of FIG. 1 is an anion exchange membrane. In this type of cell, the anode and cathode compartments are separated by a membrane that is permeable to anions such as sulfate and chloride. This configuration using an anion exchange membrane will prevent the crossover of iron ions from the positive to the negative side, as cations will be rejected by this membrane. The charge carrying ion in this configuration is the anion, (e.g., sulfate, chloride or bromide). Examples of such anion exchange membranes include, but are not limited to anion exchange membranes commercially available from Tokuyama Corporation, Fumatech and Exergy.

In a variation, the negative electrolyte includes a cyclic organic compound that is and anthraquinone derivatives having formula I:

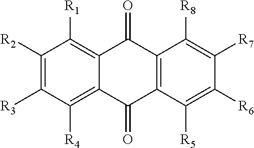

wherein:
R₁, R₂, R₃, R₄, R₅, R₆, R₇, and R₈ are —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
R′, R″ and R′″ are C₁₋₁₂ alkyl, C₆₋₁₈ aryl, or C₆₋₁₈ hetereoaryl;
L is any negatively charged counter ion; and
M is any positively charged counter ion.

In a variation, the negative electrolyte includes a cyclic organic compound that is a naphthaquinone derivative having the following formula II:

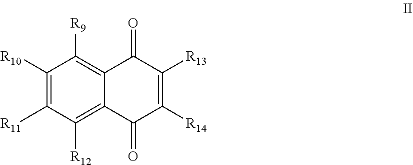

wherein:

R₉, R₁₀, R₁₁, R₁₂, R₁₃, and R₁₄ can be —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
R′, R″ and R′″ are C₁₋₁₂ alkyl, C₆₋₁₈ aryl, or C₆₋₁₈ is hetereoaryl;
L is any negatively charged counter ion; and
M is any positively charged counter ion.

In a variation, the negative electrolyte includes a cyclic organic compound that is a quinoxaline derivative having the following formulas III and IV:

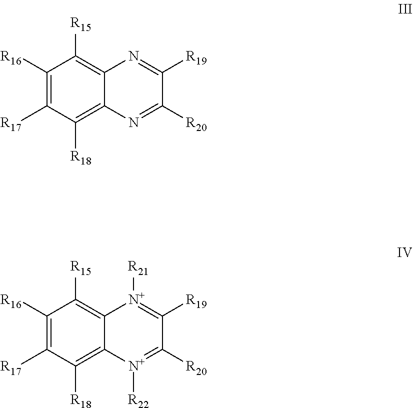

wherein:
R₁₅, R₁₆, R₁₇, R₁₈, R₁₉, R₂₀, R₂₁ and R₂₂ can be —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
R′, R″ and R′″ are C₁₋₁₂ alkyl, C₆₋₁₈ aryl, or C₆₋₁₈ hetereoaryl;
L is any negatively charged counter ion; and
M is any positively charged counter ion.

In a variation, the negative electrolyte includes a cyclic organic compound that is a phenazine derivative having the following formulas V and VI:

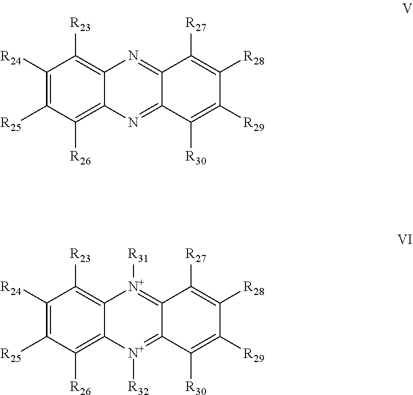

wherein:
R₂₃, R₂₄, R₂₅, R₂₆, R₂₇, R₂₈, R₂₉, R₃₀, R₃₁ and R₃₂ can be —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
R′, R″ and R′″ are C₁₋₁₂ alkyl, C₆₋₁₈ aryl, or C₆₋₁₈ hetereoaryl;
L is any negatively charged counter ion; and
M is any positively charged counter ion.

In a variation, the negative electrolyte includes a cyclic organic compound that is a phenanthroline or bipyridine derivatives having the following formulas:

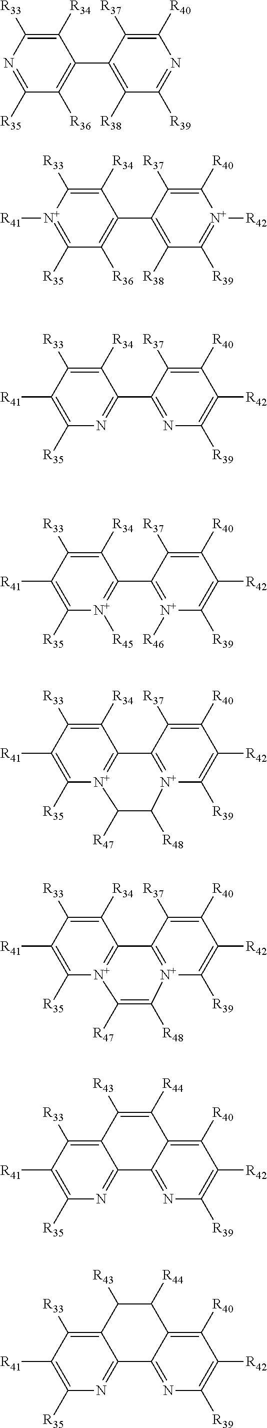

wherein:
R₃₃, R₃₄, R₃₅, R₃₆, R₃₇, R₃₈, R₃₉, R₄₀, R₄₁, R₄₂, R₄₃, R₄₄, R₄₅, R₄₆, R₄₇ and R₄₈ can be —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
R′, R″ and R′″ are C₁₋₁₂ alkyl, C₆₋₁₈ aryl, or C₆₋₁₈ hetereoaryl;
L is any negatively charged counter ion; and
M is any positively charged counter ion.

In still another refinement, Fremy's salt, K₂S₂O₇N can be dissolved in water and used as an electrolyte for the positive electrode of the organic redox flow battery. Solutions as high as 3 moles/liter can be prepared by dissolving Fremy's salt in water. Fremy's salt undergoes a one-proton one-electron reaction at a very positive electrode potential:

K₂(SO₂)₂NO+H⁺+e⁻→K₂(SO₂)₂NOH E°=1.023 V

Fremy salt can be combined with all the negative electrode materials discussed in the various inventions discussed as part of the improvements.

The following examples illustrate the various embodiments of the present invention. Those skilled in the art will recognize many variations that are within the spirit of the present invention and scope of the claims.

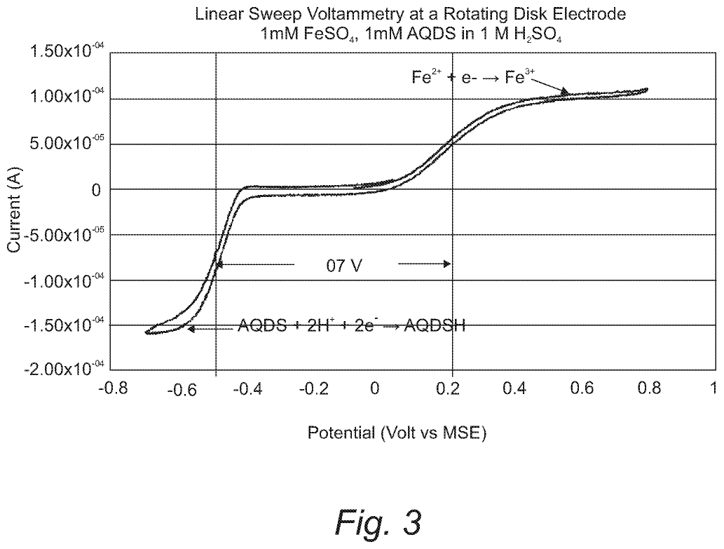

FIG. 3 provides results of linear sweep voltammetry at a rotating disk electrode that confirm the half-wave electrode potentials E_{1/2} or the positive and negative redox materials. The open-circuit cell voltage predicted from the half-wave potentials is approximately 0.7 V.

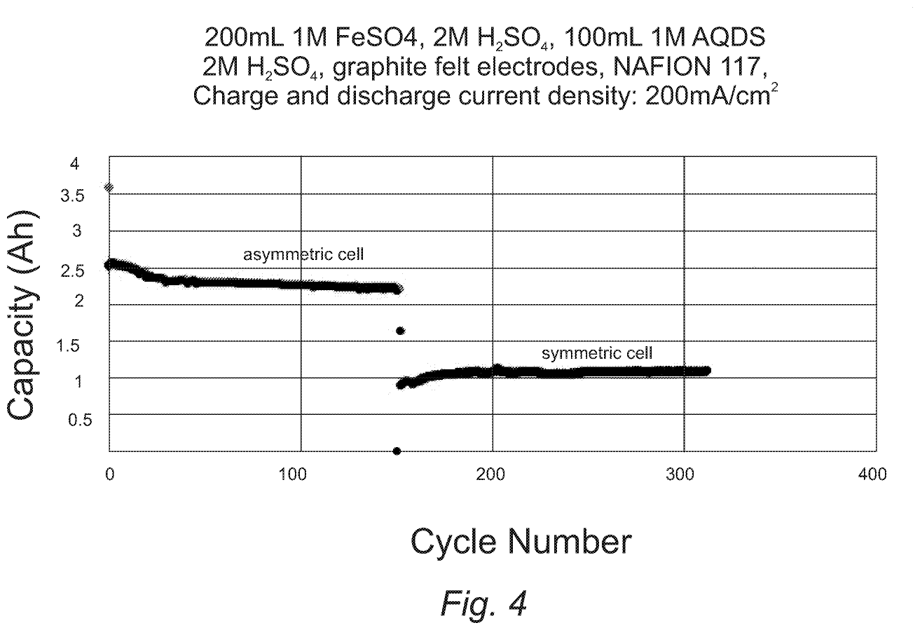

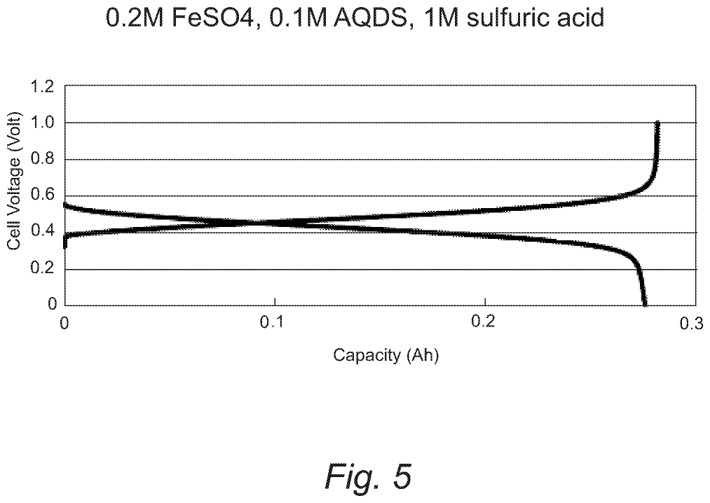

A cell with 200 mL of 1M iron (II) sulfate as the positive electrolyte and 100 mL of 1 M anthraquinone disulfonic acid as the negative electrolyte was constructed. The cell was assembled with graphite electrodes and a NAFION 117 proton exchange membrane. The electrolytes were circulated through the cell using centrifugal pumps. The charge and discharge were conducted using a Maccor Battery Cycler. The cell could be charged and discharged repeatedly over 300 cycles. FIG. 4 provides typical voltage-capacity curves during charge and discharge. It was observed an open circuit voltage of about 0.65 V, very close to the expectations from linear sweep voltammetry FIG. 5. It is observed that about 80% of the theoretical capacity during discharge, and a 100% faradaic efficiency between charge and discharge was achieved.

The cell was cycled in both asymmetric and symmetric modes at a current density of 200 mA/cm². In the asymmetric mode, the positive side had 1M iron (II) sulfate electrolyte and the negative side had 1M anthraquinone disulfonic acid. In the symmetric cell configuration, an identical mixture of iron (II) sulfate and anthraquinone disulfonic acid was used in both the positive and negative electrolyte reservoirs. After about 150 cycles in the asymmetric mode, the positive and negative electrolytes were combined and divided into equal volumes, which were then used in the positive and negative sides of the symmetric cell.

The cell could be charged and discharged multiple times in the asymmetric mode with a faradaic efficiency close to 100%. A slow capacity fade was observed in the first 20 cycles most probably due to the crossover of iron (II) and iron (III) from the positive to the negative side of the cell. To mitigate this issue, we switched to cycling the cell in the symmetric mode in which the solutions in the positive and negative electrolyte were of the same concentration. The capacity of the symmetric cell was also about half of that of the asymmetric cell, as is to be expected because of the division of electrolyte between the two sides. In this mode, the capacity remained steady with no noticeable fade over 160 cycles (FIG. 4).

The absence of capacity fade with the symmetric cell configuration confirmed that the charge/discharge cycling did not induce any degradation of the redox active materials. The advantages of symmetric cell included not only less crossover of electrolyte components, but also reduced osmotic pressure differences, and the option of switching the polarity of the electrodes to reverse any changes in electrolyte composition caused by crossover.

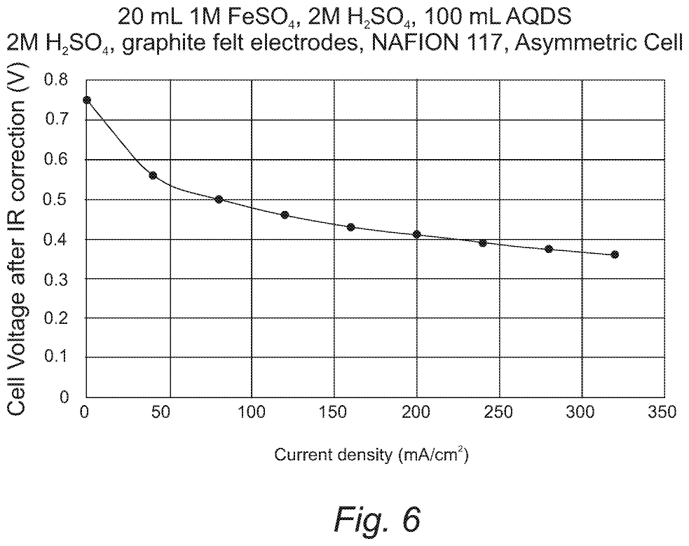

The current-voltage performance of the cell during discharge was also found to be acceptable (FIG. 6). Current densities as high 300 mA/cm² could be sustained during discharge. The cell had an internal ohmic resistance of 40 milliohms. The cell voltage was corrected to remove the voltage reduction resulting from the ohmic resistance so that we may gauge the inherent properties of the redox couples. Further improvements in cell voltage can be achieved by reducing the thickness of the membrane to 25 microns, increasing the electrochemically active area of reaction using carbon nanotube impregnated electrodes, increasing the flow rate to enhance mass transport, and increasing the temperature to improve the charge-transfer kinetics.

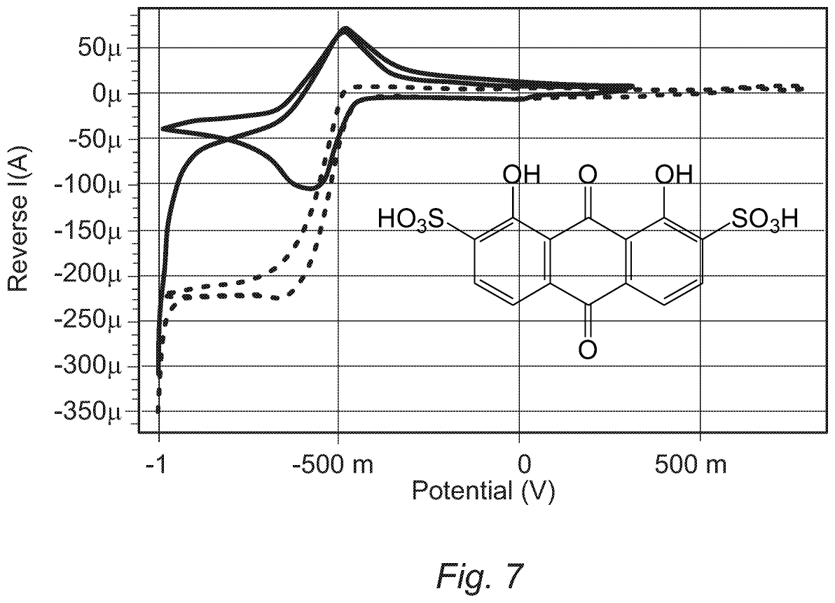

The iron/AQDS cells with proton exchange (Inventions 1 and 2) or anion exchange membrane (Invention 3) may be supplied with a variety of negative redox active electrolyte materials. These materials are aimed at providing a higher cell voltage. The cyclic voltammetry and linear sweep voltammetry of an alternative negative side material, such as dihydroxyanthraquinone disulfonic acid in 1M sulfuric acid is shown in FIG. 7. This redox couple is about 100 mV more negative potential than AQDS. Thus, dihydroxyanthraquinone disulfonic acid is an example of a negative electrolyte that will yield a higher cell voltage over the iron/AQDS cell.

A wide range of other negative electrode materials similar to AQDS were tested for their reversibility in alkaline media and found to be quite suitable and even more negative in electrode potential to AQDS. The list of their electrode potentials is shown in Table 1.

TABLE 1
Electrode potentials for various derivatives
of anthraquinone in 1M potassium hydroxide.

| Compound | Em (Volts) vs. MMO | |
|---|---|---|
| 1,2,4-trihydroxy anthraquinone | −0.84 | V |
| 2,6-dihydroxy anthraquinone | −0.8 | V |
| 1,5-dihydroxy anthraquinone | −0.65 | V |
| 1,4-dihydroxy anthraquinone | −0.63 | V |
| 1,2- dihydroxy anthraquinone | −0.73 | V |
| 1,2- dihydroxy, 3-sulfonic acid | 0.75 | V |
| anthraquinone | | |

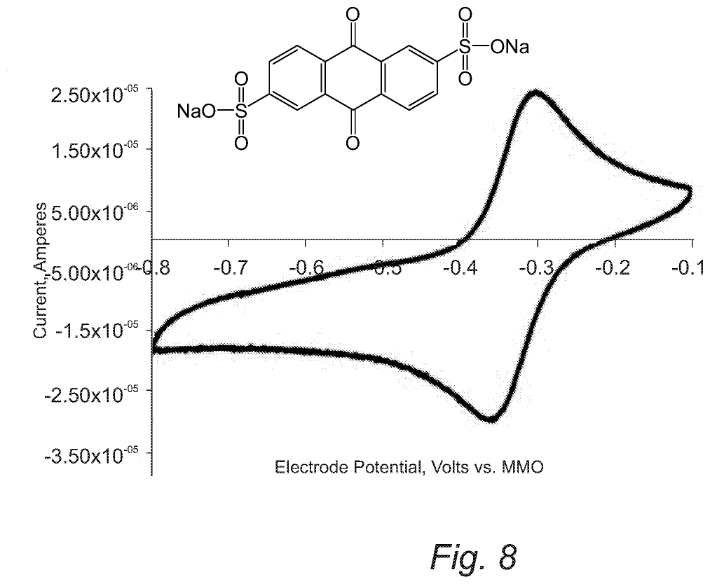

FIG. 8 provides a cyclic voltammogram of 1 mM AQDS dissolved in 1 M potassium hydroxide. In this example, the iron(II)/AQDS include an alkaline medium for the electrolyte. In this arrangement the electrolyte is a solution of potassium or sodium hydroxide in which the redox couples are dissolved. A cation exchange membrane will serve as the separator. AQDS forms soluble salts with sodium and potassium cations and is stable in an alkaline medium. FIG. 8 demonstrates that AQDS can also be reversibly oxidized and reduced in this alkaline medium.

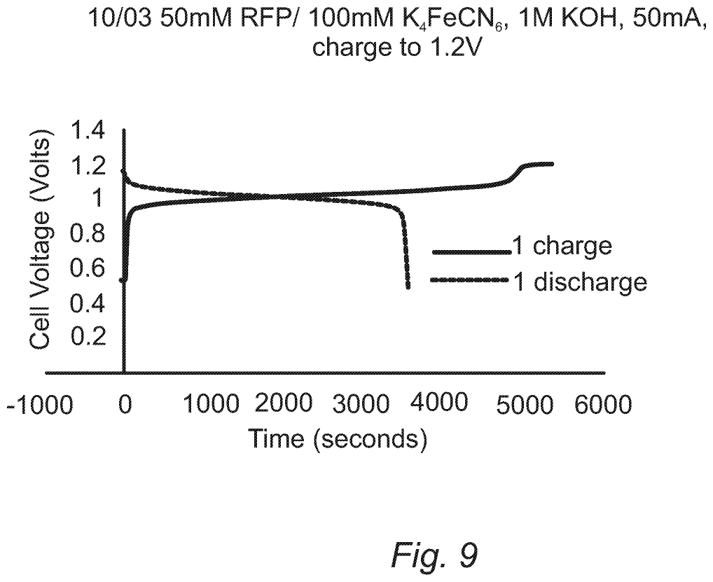

These negative electrode redox couples may be cycled with iron(II) and iron(III) complexes in the positive electrolyte. An example of such a positive electrolyte would be potassium or sodium ferrocyanide and ferricyanide ions. We have operated a cell with riboflavin electrolyte on the negative side and potassium ferrocyanide as the positive electrolyte using a NAFION™ 117 membrane as the separator. The transport of potassium ions occurs through this cell during operation. The charge/discharge cycling data shown in FIG. 9 suggests that a cell voltage value greater than 1 V is achievable with the potassium ferrocyanide electrolyte in alkaline media using redox couples similar to AQDS.

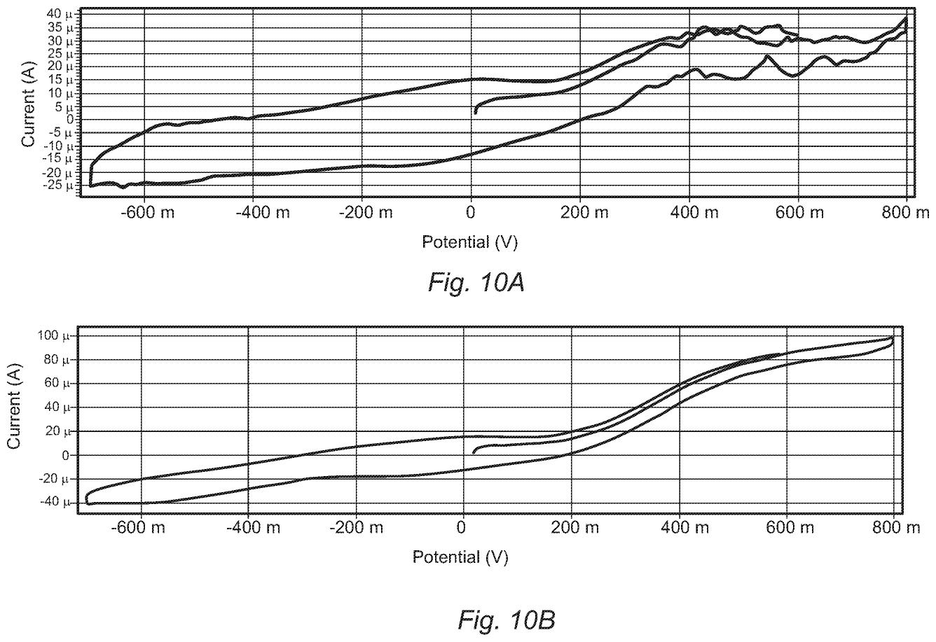

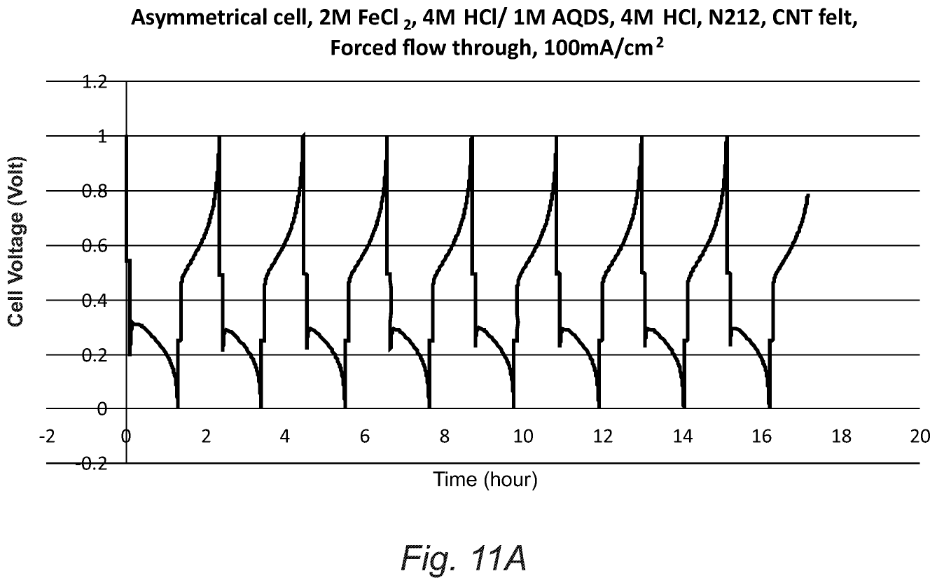

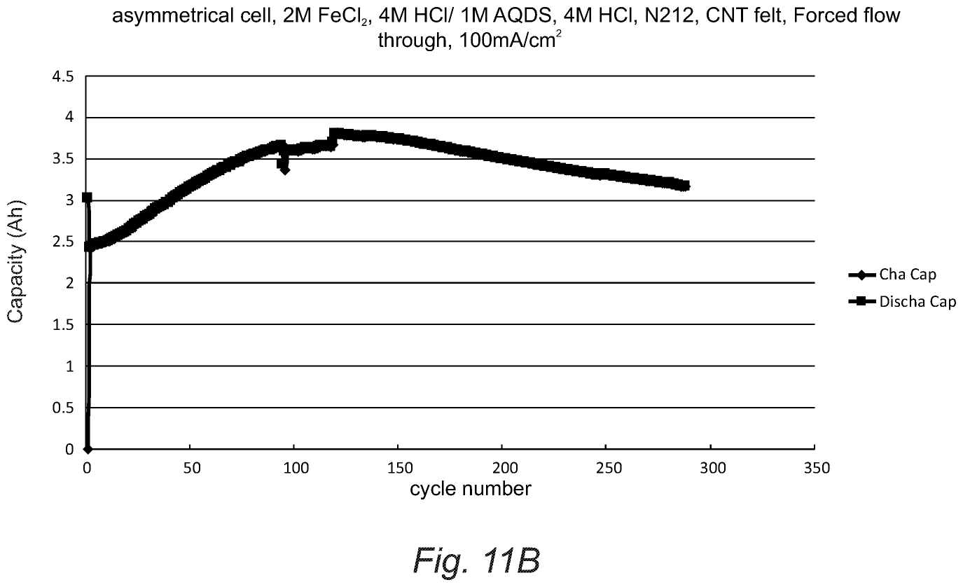

FIG. 10 shows that the oxidation of iron(i) chloride occurs at a potential of about +0.15V vs. MSE. This value is consistent with the standard electrode potential of iron(II)/iron(III) of 0.12 V vs. MSE. FIG. 11 shows that the iron(II) chloride when used as a positive electrode material in an iron/AQDS cell shows stable charge/discharge behavior when cycled at 100 mA/cm². The charge and discharge voltage for the cell remains stable from cycle to cycle. The capacity of the cell also stabilizes to a steady value in the range of 2 to 3 Ah. The iron(II) chloride cell was operated with additional chloride in the form of hydrochloric acid that is required to provide the chloride needed for the conversion iron(II chloride to iron(III)chloride.

Methanesulfonic acid unlike sulfuric acid is considered to be a “non-oxidizing” acid. Consequently, methanesulfonic acid is expected to be more compatible and less likely to produce undesirable reactions with organic compounds when compared to sulfuric acid. Therefore, we have studied the use of iron(II) methanesulfonate as a positive electrode material.

Iron(II) methanesulfonate was prepared by reacting iron with methanesulfonic acid. The resulting solution of iron(I) methanesulfonate was used for electrochemical studies.

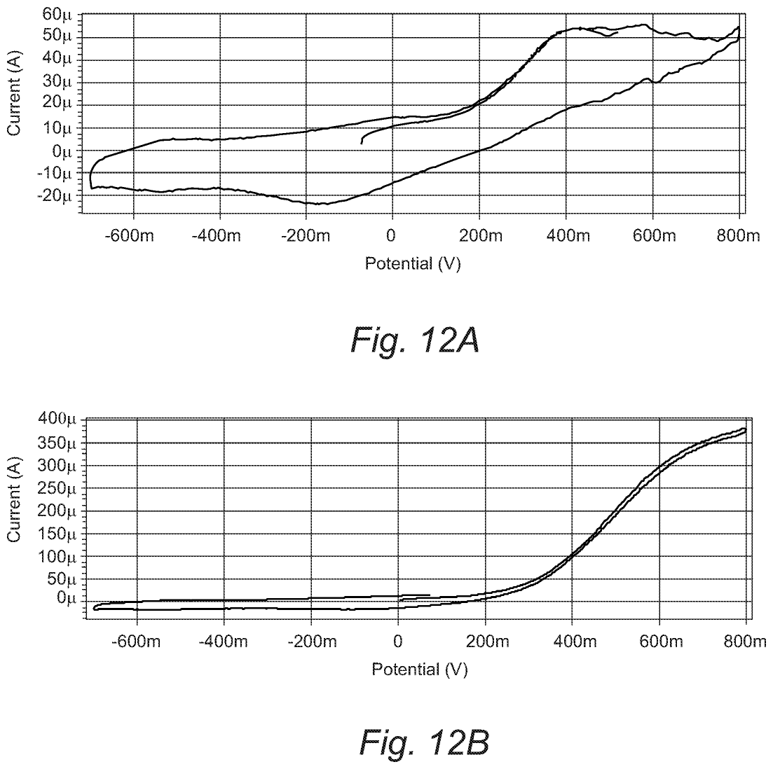

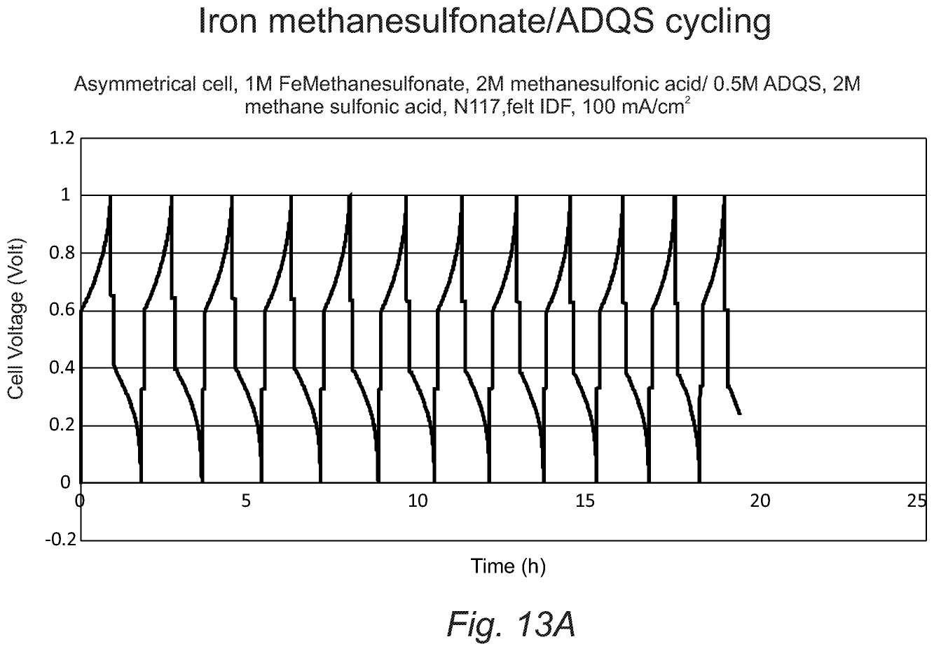

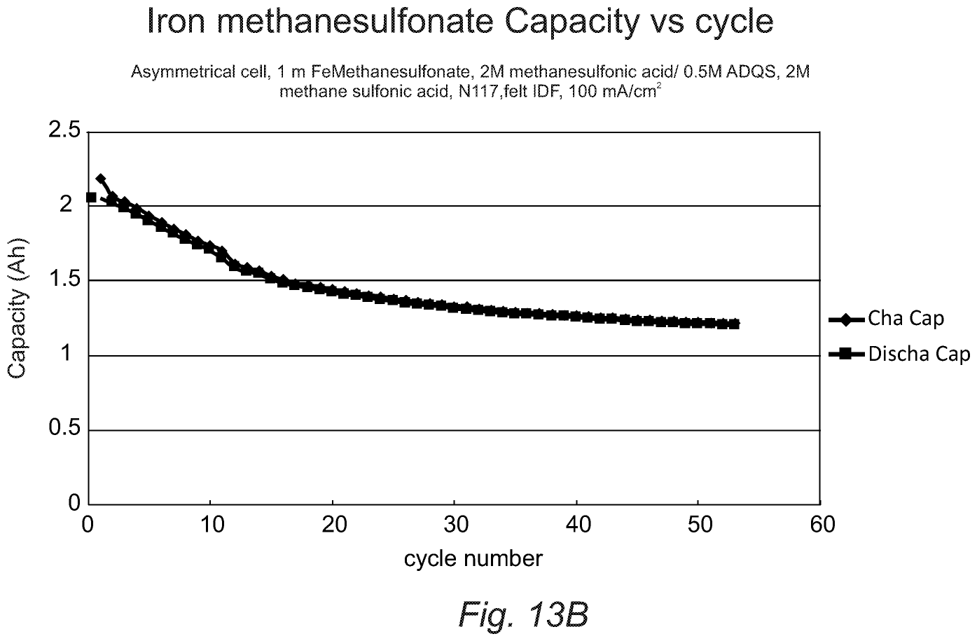

The results in FIG. 12 the same electrode potentials as iron(II) sulfate and iron(II) chloride. The electrode potential for the oxidation of iron(II) methanesulfonate is about 0.17V vs. MSE. This value of potential is very close to the standard reduction potential of the iron(II)/iron(III) redox couple. The results in FIG. 13 show that the cells with iron(II) methanesulfonate and AQDS can be cycled multiple times at 100 mA/cm² without any significant change in the shape of the charge/discharge voltage profile. This type of stable charge/discharge behavior confirms that the molecular composition of the iron salt does not undergo any change during cycling. Asymmetric cells of with iron(II) methanesulfonate could be cycled for over 50 times over which the capacity stabilized. In all the experiments, additional methanesulfonic acid added to the iron(II) methanesulfonate solutions to provide additional methanesulfonate ions needed when iron(II) is oxidized to iron(III). The slow decrease in capacity was due to the crossover of iron(II) methanesulfonate to the AQDS side of the cell. With a symmetric cell the capacity changes due to crossover can be avoided.

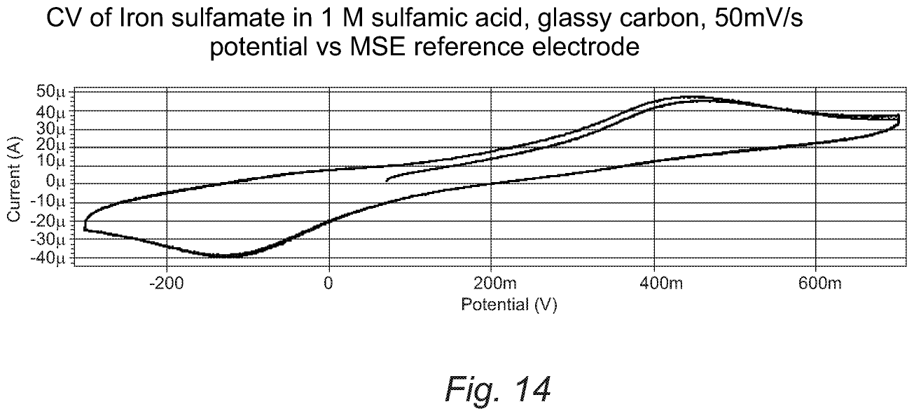

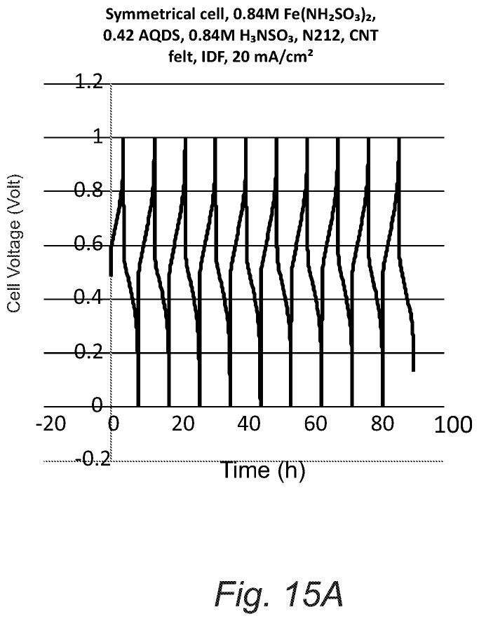

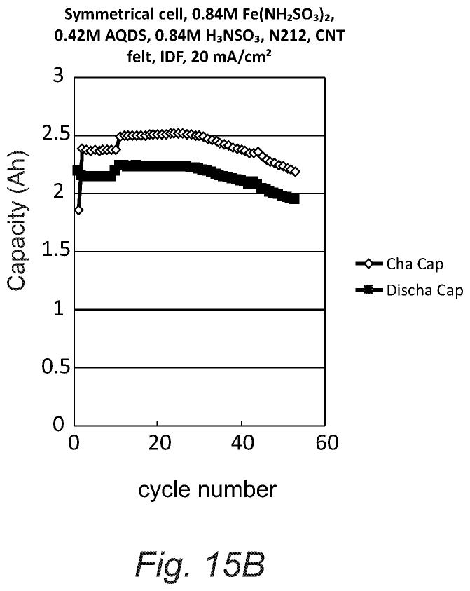

Iron(I) sulfamate may also be used as a positive electrode material. The results in FIG. 14 show that iron(II) sulfamate undergoes reversible oxidation and reduction. The electrode potential for the oxidation of iron(II)sulfamate is about 0.20 V vs. MSE. This value of potential is close to the standard reduction potential of 0.17 V vs. MSE for the iron(II)iron(II) redox couple. When iron(II) sulfamate was used a positive electrode material with AQDS as the negative electrode material, the cell was observed to undergo stable charge/discharge cycling (FIG. 15). The cell voltage profiles during charge and discharge did not change even over 50 cycles indicating that the iron(II) sulfamate salts did not undergo any noticeable change in composition. In all the experiments, additional sulfamic acid added to the iron(II) sulfamate solutions to provide additional sulfamate ions needed when iron(II) is oxidized to iron(Ill). Similarly, the capacity of the cells were stable over multiple cycles. The results presented here are for symmetrical cells that were constructed to avoid the effects of crossover.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A flow battery comprising:
a positive electrode;
a positive electrode electrolyte including a soluble iron-containing compound that is part of an iron-based redox couple, the positive electrode electrolyte flowing over and contacting the positive electrode, the soluble iron-containing compound being reduced during discharge and oxidized during charging:
a negative electrode; and
a negative electrode electrolyte including a cyclic organic compound that is part of a cyclic organic-based redox couple, the negative electrode electrolyte flowing over and contacting the negative electrode, a reduction product of the cyclic organic compound being oxidized to the cyclic organic compound during discharge and the cyclic organic compound being reduced during charging.

2. The flow battery of claim 1 wherein the soluble iron-containing compound includes Fe(II).

3. The flow battery of claim 1 wherein the soluble iron-containing compound includes a component selected from the group consisting of iron (II) chloride, iron (II) bromide, iron (II) sulfate, iron (II) methanesulfonate, iron (II) sulfamate, iron (II) triflate, and combinations thereof.

4. The flow battery of claim 1 wherein the cyclic organic compound is an anthraquinone disulfonic acid.

5. The flow battery of claim 1 wherein the soluble iron-containing compound includes complexes of iron (II) and iron (III) formed with at least one organic ligand.

6. The flow battery of claim 5 wherein the organic ligand is selected from the group consisting of citrate, ascorbate, gluconate, fumarate, EDTA, salicylate, and combinations thereof.

7. The flow battery of claim 1 wherein a temperature of operation is from 20 to 90 degrees.

8. The flow battery of claim 1 wherein positive electrode electrolyte and the negative electrode electrolyte are dissolved in water.

9. The flow battery of claim 1 further comprising an anion exchange membrane that separates an anode compartment and a cathode compartment.

10. The flow battery of claim 1 wherein the cyclic organic compound is an anthraquinone derivative having the following formula: 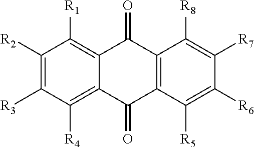
wherein:
R₁, R₂, R₃, R₄, R₅, R₆, R₇, and R₈ are —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
R′, R″ and R′″ are C₁₋₁₂ alkyl, C₆₋₁₈ aryl, or C₆₋₁₈ hetereoaryl;
L is any negatively charged counter ion; and
M is any positively charged counter ion.

11. The flow battery of claim 1 wherein the cyclic organic compound is a naphthaquinone derivative having the following formula: 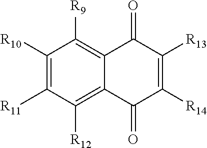
wherein:
R₉, R₁₀, R₁₁, R₁₂, R₁₃, and R₁₄ can be —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
R′, R″ and R′″ are C₁₋₁₂ alkyl, C₆₋₁₈ aryl, or C₆₋₁₈ hetereoaryl;
L is any negatively charged counter ion; and
M is any positively charged counter ion.

12. The flow battery of claim 1 wherein the cyclic organic compound is a quinoxaline derivative having one of the following formula: 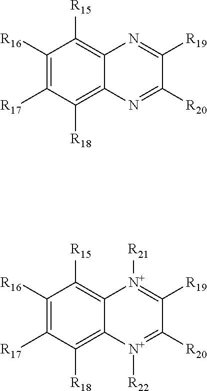
wherein:
R₁₅, R₁₆, R₁₇, R₁₈, R₁₉, R₂₀, R₂₁ and R₂₂ can be —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
R′, R″ and R′″ are C₁₋₁₂ alkyl, C₆₋₁₈ aryl, or C₆₋₁₈ hetereoaryl;
L is any negatively charged counter ion; and
M is any positively charged counter ion.

13. The flow battery of claim 1 wherein the cyclic organic compound is a phenazine derivative having one of the following formula: 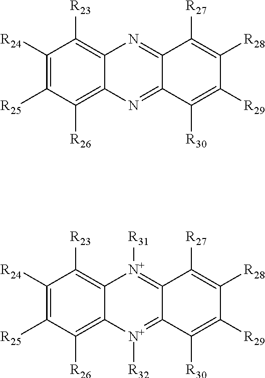
wherein:
R₂₃, R₂₄, R₂₅, R₂₆, R₂₇, R₂₈, R₂₉, R₃₀, R₃₁ and R₃₂ can be —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
R′, R″ and R′″ are C₁₋₁₂ alkyl, C₆₋₁₈ aryl, or C₆₋₁₈ hetereoaryl; and
L is any negatively charged counter ion, M is any positively charged counter ion.

14. The flow battery of claim 1 wherein the cyclic organic compound is a phenanthroline and bipyridine derivatives having a formula selected from the group consisting of: 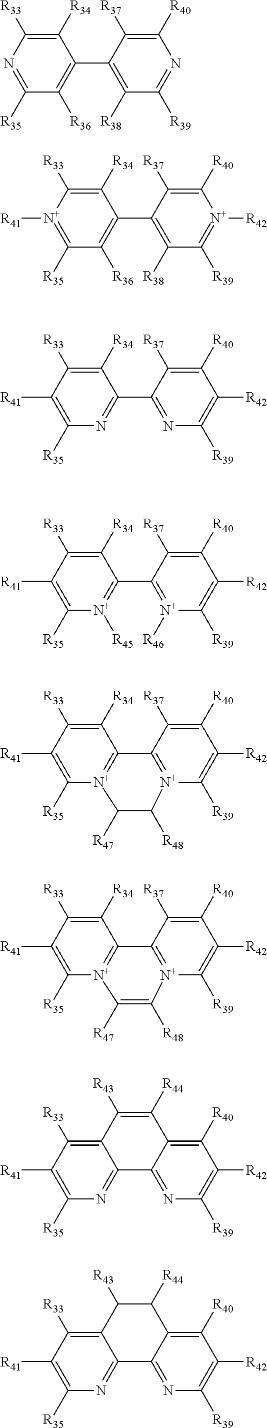
wherein:
R₃₃, R₃₄, R₃₅, R₃₆, R₃₇, R₃₈, R₃₉, R₄₀, R₄₁, R₄₂, R₄₃, R₄₄, R₄₅, R₄₆, R₄₇ and R₄₈ can be —H, —R′, —NO₂, —NH₂, —N(R′R″)₂, —N(R′R″R′″)₃⁺L⁻, —CF₃, —CCl₃, —CN, —SO₃H, —PO₃H₂, —COOH, —CO₂R′, —COR′, —CHO, —OH, —OR′, —O⁻M⁺, —SO3⁻M⁺, —PO3⁻M⁺, —COO⁻M⁺, —CF₂H, —CF₂R′, —CFH3, and —CFR′R″;
where R′, R″ and R′″ are C₁₋₁₂ alkyl, C₆₋₁₈ aryl, or C₆₋₁₈ hetereoaryl;
L is any negatively charged counter ion; and
M is any positively charged counter ion.

15. The flow battery of claim 1 wherein the positive electrode electrolyte and the negative electrode electrolyte independently have a pH from 0 to 14.

16. The flow battery of claim 1 wherein the positive electrode electrolyte and the negative electrode electrolyte independently have a pH from 0.5 to 6.5.

17. The flow battery of claim 1 wherein the positive electrode electrolyte and the negative electrode electrolyte independently have a pH 7.5 to 14.

18. The flow battery of claim 1 wherein a Fremy's salt, K₂S₂O₇N is dissolved in water and used as an electrolyte for the positive electrode of the flow battery.

19. A flow battery comprising:
a positive electrode;
a positive electrode electrolyte including a soluble iron-containing compound that is part of an iron-based redox couple, the positive electrode electrolyte flowing over and contacting the positive electrode, the soluble iron-containing compound being reduced during discharge and oxidized during charging, the soluble iron-containing compound being iron (II) chloride, iron (II) bromide, iron (II) sulfate, iron (II) methanesulfonate, iron (II) sulfamate, iron (II) triflate, or complexes of iron and organic ligands;
a negative electrode; and
a negative electrode electrolyte including a cyclic organic compound that is part of a cyclic organic-based redox couple, the negative electrode electrolyte flowing over and contacting the negative electrode, a reduction product of the cyclic organic compound being oxidized to the cyclic organic compound during discharge and the cyclic organic compound being reduced during charging.
